(19) United States
(12) Patent Application Publication
(10) Pub. No.: US 2015/0375932 A1
(43) Pub. Date: Dec. 31, 2015

(54) Temperature Controlled Container For Storing And Transporting Core Samples

(71) Applicants: David King ANDERSON, III, Houston, TX (US); Matthew B. HOFFMAN, Arvada, CO (US); Steven Lee HALL, Porter, TX (US); Jordan SMITH, Cypress, TX (US); Carrie RASTEGAR, Cypress, TX (US); Bryan WALLACE, Castle Rock, CO (US)

(72) Inventors: David King ANDERSON, III, Houston, TX (US); Matthew B. HOFFMAN, Arvada, CO (US); Steven Lee HALL, Porter, TX (US); Jordan SMITH, Cypress, TX (US); Carrie RASTEGAR, Cypress, TX (US); Bryan WALLACE, Castle Rock, CO (US)

(21) Appl. No.: 14/315,093

(22) Filed: Jun. 25, 2014

(51) Int. Cl. B65D 88/74; B65D 90/48; B65D 88/12; B65D 90/00; G01N 1/00; B65D 85/00

(52) U.S. Cl. CPC B65D 88/745; G01N 1/00; B65D 85/70; B65D 88/12; B65D 90/008; B65D 90/48

(57) ABSTRACT

A method of storing and/or transporting core samples in a temperature controlled container includes inserting a core sample into the container and inputting a temperature value into a control panel of the container. The container includes one or more reinforcement members and one or more strap guides coupled an exterior of the container. A temperature of a space within the container where the core samples are located is measured and compared to the temperature value. The space within the container where the core samples are located is heated or cooled until the temperature of the space is substantially equal to the temperature value. The container and the core samples located within the container can be transported from a drilling site to a testing facility.

### BACKGROUND OF THE INVENTION

1. Field of the Invention

Embodiments of the invention generally relate to a temperature controlled container for storing and transporting core samples.

2. Description of the Related Art

A core sample is a cylindrical piece of material, such as rock, that is drilled out from an underground formation and brought to the surface for examination. The properties of the core sample, such as porosity and permeability, as well as the contents disposed within the core sample, such as liquids and gases, are examined and used to provide a calculated estimation of the properties and contents of the underground formation. The properties and contents of the underground formation indicate whether the underground formation contains specific types and amounts of natural resources, such as oil and gas.

Information regarding the type and amount of natural resources in the underground formation is helpful to assess whether the value of the natural resources is greater than the cost of a drilling operation necessary to retrieve the natural resources. If a drilling operation to retrieve the natural resources is to be conducted, taking multiple core samples at different locations within the underground formation can also help determine where to locate the drilling equipment to recover the maximum amount of the natural resources. Thus, core sampling provides valuable information when searching for natural resources located in underground formations.

A coring tool is used to drill out one or more core samples from an underground formation. The coring tool includes a cylindrical housing that is forced into the ground to drill out a cylindrical piece of material from the underground formation. The coring tool is brought back to the surface and the core samples are removed from the coring tool. A core sample is about 3 feet to about 30 feet in length, and about 3 inches to about 6 inches in diameter.

The core samples are then transported to a testing facility, which has the equipment necessary to examine the core samples. While being transported to a testing facility, the core samples can get damaged, such as cracked or broken into multiple pieces, if not properly handled. Also, the core sample must be stored at a temperature cold enough to preserve the properties and contents within the core samples. If not properly handled and stored, the examination of the core samples can provide inaccurate information regarding the properties and contents of the underground formation from which the core samples were retrieved.

Therefore, there is a need for new and improved methods and apparatus for storing and transporting core samples.

### SUMMARY OF THE INVENTION

In one embodiment, a method of storing and/or transporting core samples in a temperature controlled container comprises inserting a core sample into a container; inputting a temperature value into a control panel of the container; measuring a temperature of a space within the container where the core samples are located; comparing the temperature of the space within the container where the core samples are located to the temperature value; heating or cooling the space within the container where the core samples are located until the temperature of the space is substantially equal to the temperature value; and transporting the container and the core samples located within the container from a drilling site to a testing facility.

In one embodiment, a temperature controlled container comprises an outer housing having a door movable between an open and a closed position; one or more reinforcement members and one or more strap guides coupled to the outer housing; a control panel coupled to the outer housing; a temperature control system disposed within the outer housing and in communication with the control panel; and a support member disposed within the outer housing configured to support one or more core samples.

### BRIEF DESCRIPTION OF THE DRAWINGS

So that the manner in which the above recited features can be understood in detail, a more particular description, briefly summarized above, may be had by reference to the embodiments, some of which are illustrated in the appended drawings. It is to be noted, however, that the appended drawings illustrate only typical embodiments and are therefore not to be considered limiting of its scope, for the invention may admit to other equally effective embodiments.

FIG. 1 illustrates a schematic view of a coring tool lowered into an underground formation to retrieve one or more core samples from the underground formation, as well as a temperature controlled container located on a vehicle to transport the core samples to a testing facility.

FIG. 2A illustrates a temperature controlled container in a closed position, according to one embodiment.

FIG. 2B illustrates the temperature controlled container in an open position, according to one embodiment.

FIG. 3A illustrates another temperature controlled container in a closed position, according to one embodiment.

FIG. 3B illustrates the temperature controlled container in an open position, according to one embodiment.

FIG. 4 illustrates a schematic of a temperature control system configured to control the temperature within the temperature controlled container, according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

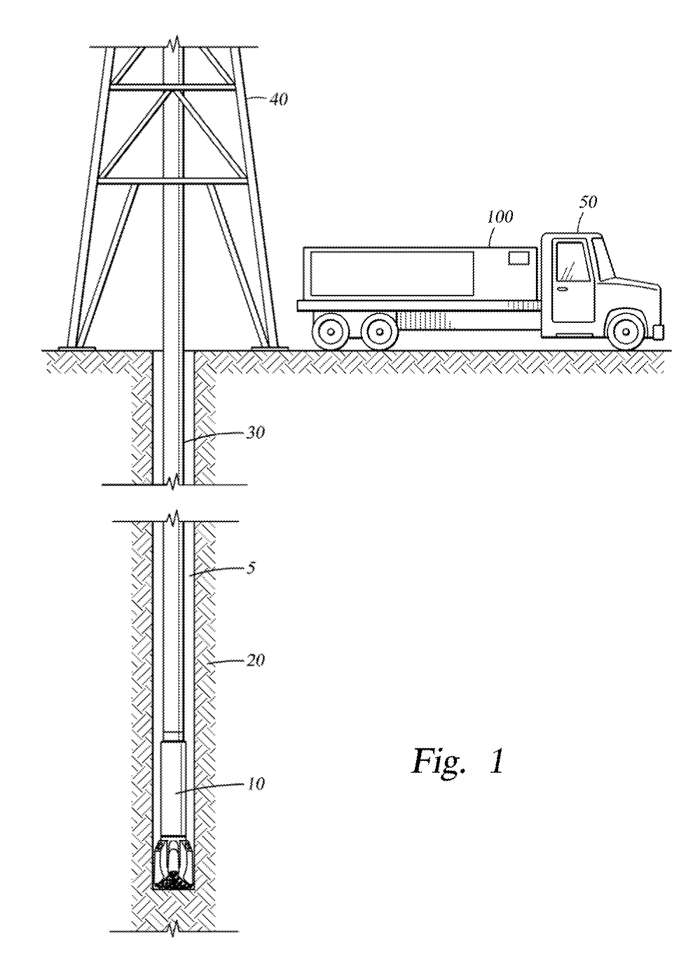

FIG. 1 illustrates a coring tool 10 having a drill bit that is lowered into the ground to form a borehole 5 and drill out one or more core samples from an underground formation 20. The core samples are pieces of material, such as rock, that are drilled out from the underground formation 20 and brought to the surface for examination. The coring tool 10 is lowered into the borehole 5 by a work string 30, such as a plurality of tubular members coupled together, which is supported at the surface by a rig structure 40 at a drilling site or location. The work string 30 may be rotated, lowered, and raised, such as by a top drive system as known in the art, to rotate, lower, and raise the coring tool 10 into and out of the borehole 5. The core samples can be removed from the coring tool 10, optionally cut into multiple sections, and then inserted into a temperature controlled container 100. In one embodiment, the core samples may be pressurized core samples that are removed from the coring tool 10 in fully sealed tubes so that the core samples are not exposed to the surrounding atmosphere to help preserve the contents within the pressurized core samples.

A temperature controlled container 100 is located on a vehicle 50 for storing and transporting one or more core samples from the drilling site or location to a testing facility. The container 100 is configured to maintain the core samples located within the container 100 at a temperature cold or hot enough to preserve the contents, e.g. liquids and gases, within the core samples for examination. The container 100 is also configured to store the core samples so that they are not damaged, e.g. cracked or broken into multiple pieces, while being transported to the testing facility. Examples of a container that can be used with the embodiments of the invention described herein are the containers 100, 600, and 800 illustrated and described in U.S. Publication No. 2004/0226309, the contents of which are herein incorporated by reference in its entirety.

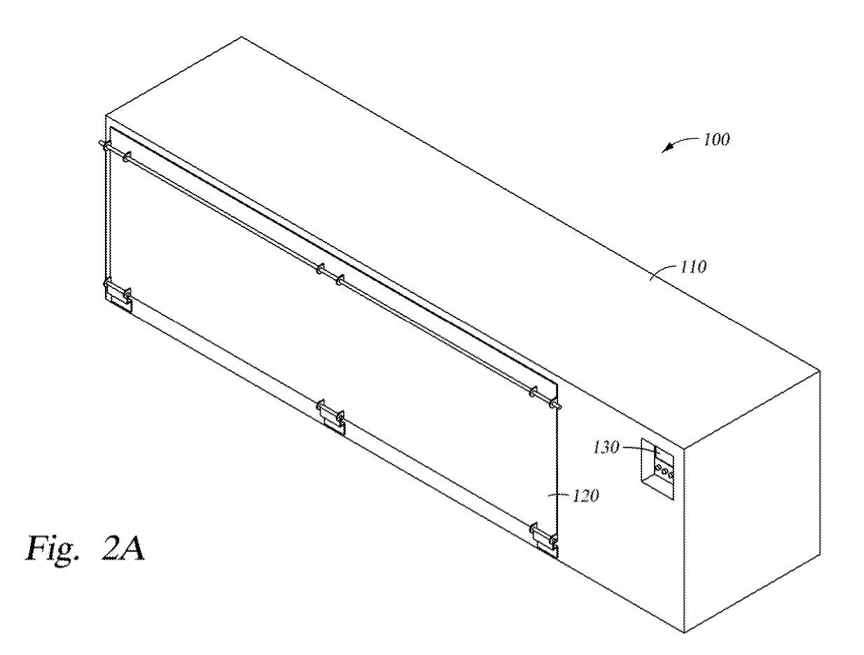

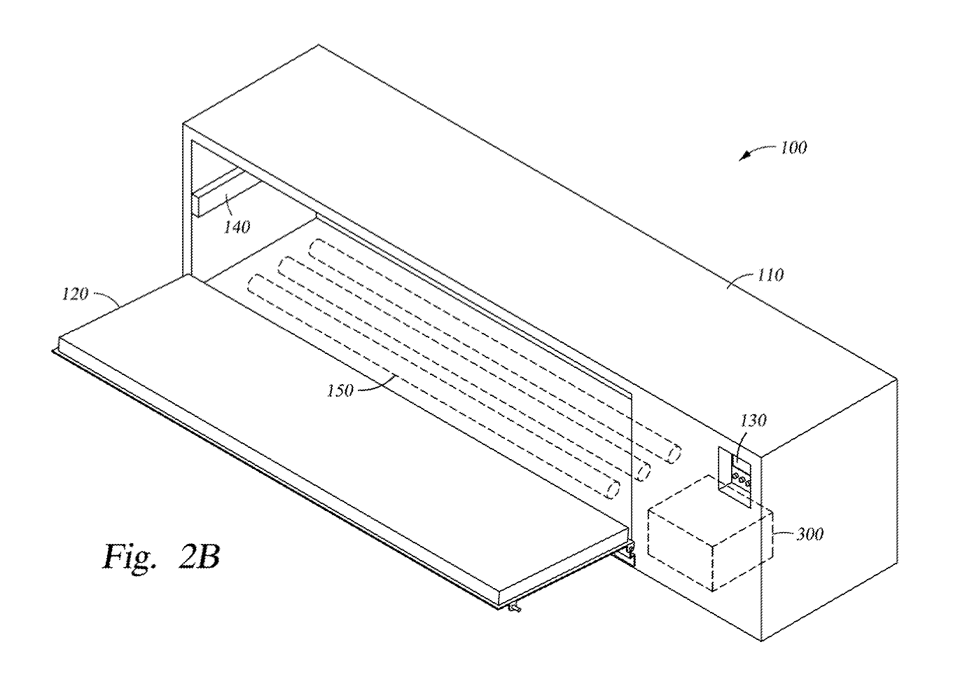

FIG. 2A illustrates the temperature controlled container 100 in a closed position, according to one embodiment. The container 100 includes an outer housing 110, a door 120, and a control panel 130. The outer housing 110 is a rectangular-shaped, insulated structure configured to store one or more cores samples 150 (illustrated in FIG. 2B) within the outer housing 110. The inner and/or outer walls of the outer housing 110 can be formed by or covered with insulated vacuum panels. The length of the outer housing 110 is greater than the height of the outer housing 110. Although illustrated as having a rectangular shape, the outer housing 110 may be formed in other shapes.

The door 120 is pivotably connected, such as by a hinge, to the outer housing 110 and movable between opened and closed positions to allow insertion and removal of core samples 150 into and out of the interior of the outer housing 110. The door 120 forms a sealed engagement with the outer housing 110 when in the closed position to help maintain a desired temperature within the outer housing 110 as further described below. A control panel 130 having a display and one or more control buttons, switches, dials, etc., is also integrated into and coupled to the outer housing 110. The control panel 130 allows an operator to view the current temperature within the outer housing 110 and to input a desired temperature value to maintain within the outer housing 110.

FIG. 2B illustrates the container 100 with the door 120 in an open position and with the core samples 150 positioned within the interior of the outer housing 110. Although only three core samples 150 are illustrated, the container 100 can be sized to fit any number of core samples 150 as needed. One or more guide rails, such as guide rail 140, can be coupled to an interior side wall of the outer housing 110 (with corresponding guide rails coupled to the opposing interior side wall) for supporting one or more shelves that can hold additional core samples 150. Using these guiderails and/or shelves, multiple horizontal layers of core samples 150 can be arranged and stored within the outer housing 110. In one embodiment, the shelves can be movable along the guide rails so that when the door 120 is open the shelves can extend at least partially out from the interior of the outer housing 110 to easily place and remove the core samples 150 onto and from the shelves. In one embodiment, the container 100 may be configured to hold up to nine or more core samples 150 that range from about 3 feet to about 30 feet in length (10 feet in length as a specific example) and that range from about 3 inches to about 6 inches in diameter. In one embodiment, the container 100 may be configured to hold core samples 150 that range from about 2-3 inches to about 2-3 feet in length and that range from about 0.5 inches to about 2-3 inches in diameter.

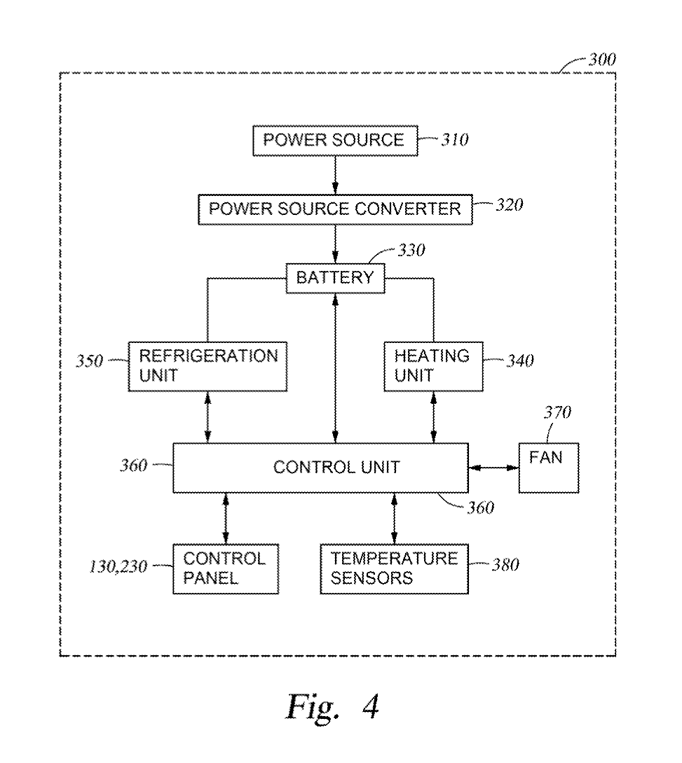

Also illustrated in FIG. 2B is a temperature control system 300 disposed within the outer housing 110. One or more, if not all, of the components of the temperature control system 300 are positioned in a compartment within the outer housing 110 separate from the interior where the core samples 150 are located. The temperature control system 300 is configured to heat, cool, and maintain the temperature within the interior of the outer housing 110 where the core samples 150 are stored. The control panel 130 can be part of the temperature control system 300 as further described below with respect to FIG. 4.

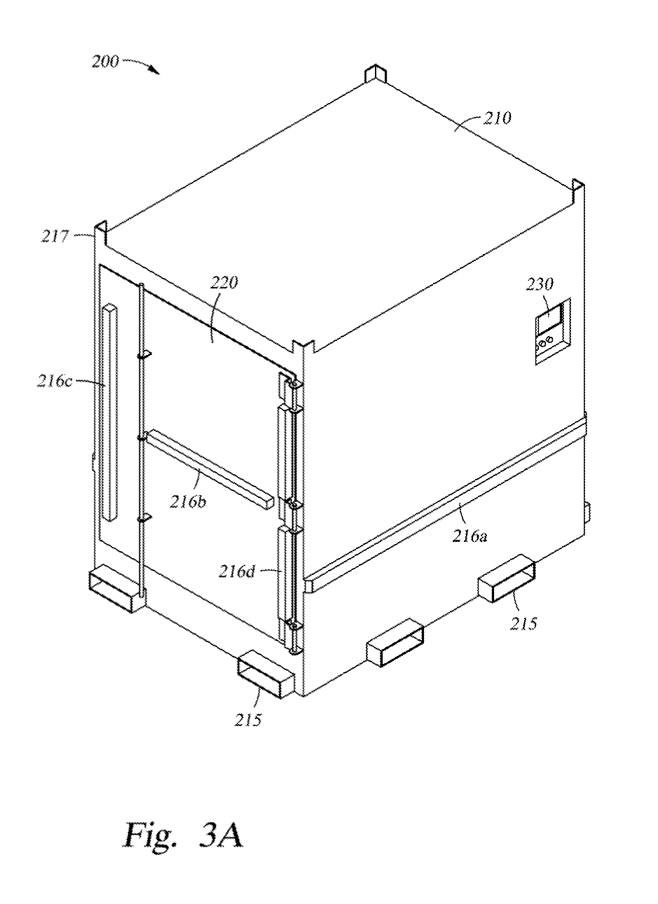

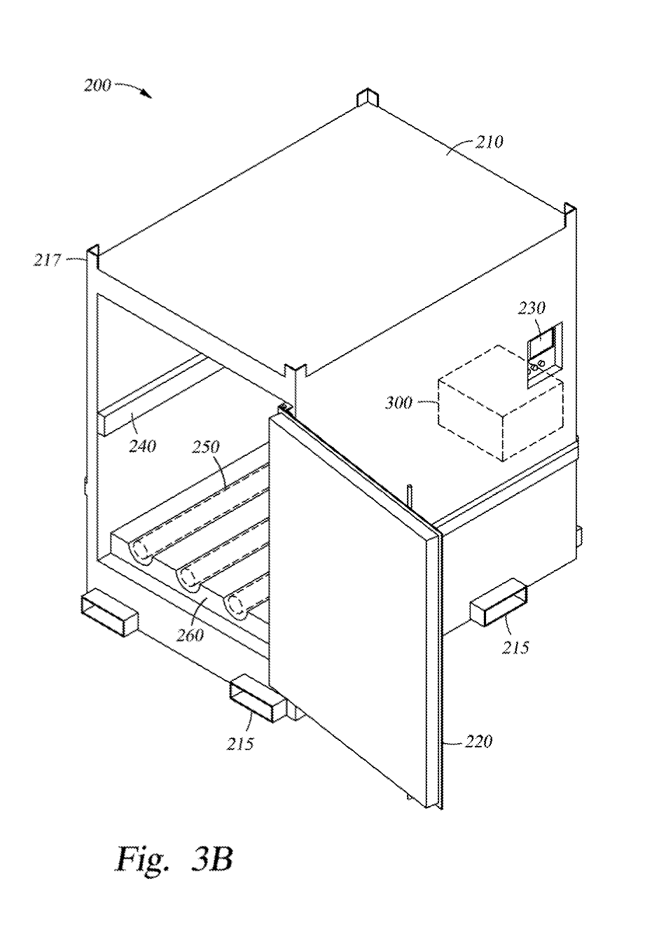

FIG. 3A illustrates the temperature controlled container 200 in a closed position, according to one embodiment. The container 200 includes an outer housing 210, a door 220, and a control panel 230, similar to the container 100 illustrated in FIG. 2A and 2B. The outer housing 210 is a rectangular-shaped, insulated structure configured to store one or more cores samples 250 (illustrated in FIG. 3B) within the outer housing 210. The length of the outer housing 210 can be greater than or substantially equal to the height of the outer housing 210. Although illustrated as having a rectangular shape, the outer housing 210 may be formed in other shapes.

The door 220 is pivotably connected, such as by a hinge, to the outer housing 210 and movable between opened and closed positions to allow insertion and removal of core samples 250 into and out of the interior of the outer housing 210. The door 220 forms a sealed engagement with the outer housing 210 when in the closed position to help maintain a desired temperature within the outer housing 210 as further described below. A control panel 230 having a display and one or more control buttons, switches, dials, etc., is also integrated into the outer housing 210. The control panel 230 allows an operator to view and visually monitor the temperature within the outer housing 210 and to input a desired temperature value at which to maintain within the outer housing 210.

Referring to FIG. 3A, one or more openings 215 are located at the base of the outer housing 210 on all four sides so that the forks of a forklift truck can be placed under the container 200 to move it as needed, such as onto and off of the vehicle 50 illustrated in FIG. 1. The outer housing 210 may also include one or more reinforcement members 216a, 216b, 216c, and 216d coupled to the exterior of the outer housing 210 to help increase the structural integrity of the container 200 and to prevent damage to the outer housing 210. Specifically, the reinforcement members 216a, 216b, 216c, and 216d may include one or more metallic strips of material that are welded to the outer housing 210 and/or the door 220 to protect the container 200 from any external impacts, such as by a forklift when moving the container 200. Similar types of reinforcement members may be disposed on the interior walls of the container 200.

The outer housing 210 may further include one or more strap guides 217 positioned at all four corners of the top of the outer housing 210. The strap guides 217 may be used to prevent any types of straps that are wrapped around the container 200 from slipping off of the outer housing 210, such straps used during transportation to secure the container 200 to the vehicle 50 illustrated in FIG. 1. The container 100 illustrated in FIGS. 2A, 2B may similarly include openings 215, reinforcement members 216a, 216b, 216c, and 216d, and/or strap guides 217.

FIG. 3B illustrates the container 200 with the door 220 in an open position and with the core samples 250 positioned within the interior of the outer housing 210. One or more support members 260 can be inserted into and removed from the interior of the outer housing 210 to support the core samples 250. The support member 260 may be formed from a foam material and/or include one or more grooves to help secure and protect the core samples 250 from any external impacts, such as during transportation of the container 200. Multiple support members 260 may be positioned on top of each other in a stacked configuration to store and transport multiple core samples 250, while allowing sufficient air circulation across the multiple core samples 250. Although only three core samples 250 are illustrated, the container 200 can be sized to fit any size and number of core samples 250 as needed.

One or more guide rails, such as guide rail 240, can be coupled to an interior side wall of the outer housing 210 (with corresponding guide rails coupled to the opposing interior side wall) for supporting one or more support members 260, which may serve as shelves that can hold additional core samples 250. Using these guiderails 240 and/or support members 260, multiple horizontal layers of core samples 250 can be arranged and stored within the outer housing 210. In one embodiment, the support members 260 can be coupled to and movable along the guide rails 240 so that when the door 220 is open the support members 260 can extend at least partially out from the interior of the outer housing 210 to easily place and remove the core samples 260 onto and from the support members 260. In one embodiment, the container 200 may be configured to hold up to nine or more core samples 250 that range from about 3 feet to about 30 feet in length (10 feet in length as a specific example) and that range from about 3 inches to about 6 inches in diameter. In one embodiment, the container 200 may be configured to hold core samples 250 that range from about 2-3 inches to about 2-3 feet in length and that range from about 0.5 inches to about 2-3 inches in diameter. The support members 260 can similarly be used with the container 100 illustrated in FIGS. 2A, 2B.

Also illustrated in FIG. 3B is the temperature control system 300 disposed within the outer housing 210. One or more, if not all, of the components of the temperature control system 300 are positioned in a compartment within the outer housing 210 separate from the interior where the core samples 250 are located. The temperature control system 300 is configured to heat, cool, and maintain the temperature within the interior of the outer housing 210 where the core samples 250 are stored. The control panel 230 can be part of the temperature control system 300 as further described below with respect to FIG. 4.

FIG. 4 illustrates a schematic of the temperature control system 300 configured to control the temperature within the temperature controlled containers 100, 200 described above, according to one embodiment. The system 300 can include the control panels 130, 230 that allow an operator view and monitor the temperature within the containers 100, 200, and/or to input a desired temperature value at which to maintain within the containers 100, 200. Optionally, the system 300 can include a temperature recorder which stores the temperature history of the core samples during transportation.

The system 300 includes a temperature control unit 360 that is in communication with one or more temperature sensors 380 to monitor the temperature within the interior of the containers 100, 200 where the core samples are located. The temperature sensors 380 can send one or more electronic signals via wired or wireless communication to the control unit 360, the electronic signals corresponding to the measure temperature within the containers 100, 200. The control unit 360 may include a programmable logic controller or other electronic processing unit having memory, mass storage devices, clocks, cache, input/output controls, additional power supplies, and/or additional display units. The control unit 360 is capable of sending data to, receiving data from, and/or controlling the operation of a heating unit 340, a refrigeration (cooling) unit 350, a fan 370, and the control panels 130, 230.

Power is supplied to the heating unit 340, the refrigeration unit 350, and the control unit 360 by a rechargeable battery 330, which can be charged with power by an alternating current or direct current power source 310 via an optional power source converter 320. The control unit 360 controls the flow of power from the battery 330 to the heating unit 340 and the refrigeration unit 350 depending on whether the core samples within the containers 100, 200 need to be heated or cooled to obtain a temperature value that is input into the control panels 130, 230. The heating unit 340 may include a heater to heat air directed by the fan 370 into the space where the core samples are located. The heating unit 340 may include a heater (or other type of heating device) to heat air that is blown by the fan 370 into the interior space where the core samples are located. The refrigeration unit 350 may include a compressor (or other type of cooling device) to cool air that is blown by the fan 370 into the space where the core samples are located. The outer housings 110, 210 may include air vents with a filtration system to prevent dust or other debris from contaminating the core samples while allowing air to circulate within, into, and/or out of the containers 100, 200.

According to one method of operation, one or more core samples are drilled out from an underground formation. The core samples are optionally cut into multiple sections, or are pressurized core samples that are disposed within fully sealed enclosures. The core samples are inserted into the container 100, 200 and supported by one or more support members 260 to protect the core samples from damage during transportation or other movement of the container 100, 200. An operator can input a desired temperature value into the control panel 130, 230, which is communicated to the control unit 360. The control unit 360 continuously receives electronic signals from the temperature sensors 380 corresponding to the temperature within the container 100, 200 where the core samples are located. The control unit 360 compares the temperature measurements measured by the temperature sensors 380 with the temperature input into the control panel 130, 230. If the temperature within the container 100, 200 where the core samples are located is not substantially equal to (e.g. less than or greater than) the temperature value input into the control panel 130, 230, then the control unit 360 initiates operation of the fan 370 and the heating unit 340 to supply hot air to increase the temperature, or initiates operation of the fan 370 and the refrigeration unit 350 to supply cold air to lower the temperature, of the space where the core samples are located until the temperature in the space where the core samples are located is substantially equal to the temperature value input into the control panel 130, 230. The control unit 360 can initiate operation of the fan 370, the heating unit 340, and/or the refrigeration unit 350 by controlling power supplied to the fan 370, the heating unit 340, and/or the refrigeration unit 350 from the battery 330 and/or power source 310.

The control unit 360 continuously monitors and records the temperature within the space where the core samples are located via the temperature sensors 380, and if needed, starts and stops operation of the fan 370 and the heating unit 340 or the refrigeration unit 350 to maintain the temperature at the desired temperature value. The temperature within the container 100, 200 can be changed by inputting a different temperature value using the control panels 130, 230. In one embodiment, the desired temperature value can be input and/or changed from a remote location by sending a corresponding wireless signal to the control unit 360. The control unit 360 will adjust the temperature within the container 100, 200 until the temperature is substantially equal to the input or changed temperature value. The container 100, 200 can be transported from a drilling site or location to a remote testing facility where the contents within the core samples can be examined. The location of the container 100, 200 can be monitored, in real-time, from a location remote from the location of the container 100, 200 using a tracking system, such as a global positioning system (GPS).

While the foregoing is directed to embodiments of the invention, other and further embodiments of the invention may be devised without departing from the basic scope thereof, and the scope thereof is determined by the claims that follow.

1. A temperature controlled container, comprising:
an outer housing having a door movable between an open and a closed position;
one or more reinforcement members and one or more strap guides coupled to the outer housing;
a control panel coupled to the outer housing;
a temperature control system disposed within the outer housing and in communication with the control panel; and
a support member disposed within the outer housing configured to support one or more core samples.

2. The container of claim 1, further comprising one or more temperature sensors coupled to the outer housing and in communication with the temperature control system.

3. The container of claim 2, wherein the temperature control system includes a control unit configured to receive a temperature measurement from the one or more sensors.

4. The container of claim 3, wherein the control unit is configured to initiate operation of a heating unit, a refrigeration unit, and a fan disposed within the outer housing.

5. The container of claim 4, wherein the support member is coupled to a guide rail that is coupled to an interior wall of the outer housing.

6. A method of storing and/or transporting core samples in a temperature controlled container, comprising:
inserting a core sample into a container;
inputting a temperature value into a control panel of the container;
measuring a temperature of a space within the container where the core samples are located;
comparing the temperature of the space within the container where the core samples are located to the temperature value; and
heating or cooling the space within the container where the core samples are located until the temperature of the space is substantially equal to the temperature value.

7. The method of claim 6, further comprising maintaining the temperature within the space where the core samples are located substantially equal to the temperature value.

8. The method of claim 6, further comprising changing the temperature value by sending a wireless signal to a control unit of the container, and adjusting the temperature within the space where the core samples are located until the temperature is substanitally equal to the changed temperature value.

9. The method of claim 6, further comprising tracking the location of the container from a remote location.

10. The method of claim 6, further comprising initiating operation of a fan and a heating unit disposed within the container to increase the temperature of the space within the container where the core samples are located.

11. The method of claim 6, further comprising initiating operation of a fan and a refrigeration unit disposed within the container to lower the temperature of the space within the container where the core samples are located.

12. The method of claim 6, further comprising controlling power supplied to a heating unit and a refrigeration unit to initiate heating or cooling of the space within the container where the core samples are located.

13. The method of claim 6, wherein the core sample is disposed in a groove formed on a support member that is positioned within the container, wherein the support member is formed from a foam material.

14. The method of claim 6, wherein the core sample is disposed on a support member that is coupled to a guide rail located on an interior side wall of the container.

15. The method of claim 6, wherein the container includes one or more reinforcment members coupled to an exterior of the container.

16. The method of claim 6, wherein the container includes one or more strap guides coupled to a top of the container.

17. The method of claim 6, wherein a length of the container is greater than a height of the contanier.

18. The method of claim 6, wherein the core sample located within the container is about 3 feet to about 30 feet in length, and about 3 inches to about 6 inches in diameter.

19. The method of claim 6, further comprising recording the temperature of the space within the container where the core sample is located.

20. The method of claim 6, further comprising transporting the container and the core samples located within the container from a drilling site to a testing facility.
